(19) United States
(12) Patent Application Publication
(10) Pub. No.: US 2024/0383349 A1
(43) Pub. Date: Nov. 21, 2024

(54) Interconnecting Electric Components in a Charger for an Electric Vehicle

(71) Applicant: FREEWIRE TECHNOLOGIES, INC., Newark, CA (US)

(72) Inventors: Aaron Rogers, Newark, CA (US); Christopher Wilke, Newark, CA (US); Nikola Milivojevic, Boulder, CO (US)

(21) Appl. No.: 18/614,615

(22) Filed: Mar. 22, 2024

Related U.S. Application Data
(60) Provisional application No. 63/491,683, filed on Mar. 22, 2023.
(60) Provisional application No. 63/491,695, filed on Mar. 22, 2023.
(60) Provisional application No. 63/491,715, filed on Mar. 22, 2023.

(51) Int. Cl. B60L 53/14

(52) U.S. Cl. CPC B60L 53/14; B60L 2210/10; B60L 2210/30; B60L 2210/46

(57) ABSTRACT

A charger for an electric vehicle (EV) comprises a printed circuit board (PCB) on which power circuits defining respective phases of a multi-phase power conversion circuit are disposed along a first dimension, a conductive input bus bar mounted on a surface of the PCB and extending along the first dimension, a conductive output bus bar mounted on the surface of the PCB and extending along the first dimension parallel to the input bus bar, an input connector disposed at an end of the input bus bar, configured to receive input power for the plurality of power circuits; and an output connector disposed at an end of the output bus bar, configured to receive output power from the plurality of power circuits. The input bus bar and the output bus bar provide a substantially equal, low-resistance resistance path for current distribution to each of the plurality of power circuits.

### CROSS-REFERENCE TO RELATED APPLICATIONS

This application claims priority to and the benefit of the filing date of provisional U.S. Patent Application 63/491,683, titled “Surface Mount Bus Bar,” filed on Mar. 22, 2023, provisional U.S. Patent Application 63/491,695, titled “Port Design for a Charging Station,” filed on Mar. 22, 2023, and provisional U.S. Patent Application 63/491,715, titled “Thermally Enhanced Toroid” filed on Mar. 22, 2023. The entire contents of these provisional applications are hereby expressly incorporated herein by reference.

### TECHNICAL FIELD

This application generally relates to improvements to charging stations generally and, more particularly, to improvements in interconnecting electrical components within a charging station.

### BACKGROUND

Charging stations for electric vehicles (EVs), referred to below also as “EV Supply Equipment” (EVSEs), “EV chargers,” or simply as “chargers,” provide electric power to electric vehicles (EVs), including plug-in hybrid vehicles, that can operate without the use or with limited use of hydrocarbon-based fuels. Installation of conventional charging stations typically requires improvements to infrastructure including upgrades to electrical service and construction of suitable housing. The costs, planning, and time required to install these charging systems can be a deterrent to potential commercial or residential operators. To reduce the installation and operating requirements associated with traditional charging stations, some charging stations include batteries to store energy received from a power source (such as an electric utility power grid) over an extended time interval.

An EV charger can include power conversion circuits including multi-phase circuits. In a multi-phase charging station, it is difficult to achieve equal resistance in the electric paths connecting DC-to-DC converter components and ports of the charging system. Further, an EV charger can include multiple power boards, which usually are interconnected using a harness and numerous cables. However, harnesses are generally unreliable.

Still further, power electronics in an EV charger generate a large amount of heat. For example, an inductor of DC-to-DC converter loses some of the electrical energy to heat, which the EV charger then needs to remove using a cooling unit, which in turn requires energy and increases the size of the charging station.

### SUMMARY

An example embodiment of the techniques of this disclosure is a charger for an electric vehicle (EV). The charger comprises a printed circuit board (PCB) on which a plurality of power circuits defining respective phases of a multi-phase power conversion circuit are disposed along a first dimension; a conductive input bus bar mounted on a surface of the PCB and extending along the first dimension; a conductive output bus bar mounted on the surface of the PCB and extending along the first dimension parallel to the input bus bar; an input connector disposed at an end of the input bus bar, configured to receive input power for the plurality of power circuits; and an output connector disposed at an end of the output bus bar, configured to receive output power from the plurality of power circuits. The input bus bar and the output bus bar provide a substantially equal, low-resistance resistance path for current distribution to each of the plurality of power circuits.

Another example embodiment of these techniques is an assembly in a charger for an electric vehicle (EV). The assembly comprises a contactor board including first and second contactor bus-bars soldered to the contactor board perpendicular to a surface of the contactor board; a first rack-mountable printed circuit board (PCB) in a perpendicular orientation relative to the contactor board, the first rack-mountable PCB mechanically supporting the contactor board via the first contactor bus-bars; a second rack-mountable PCB in he perpendicular orientation relative to the contactor board and parallel to the first rack-mountable PCB, the second rack-mountable PCB mechanically supporting the contactor board via the second contactor bus-bars. The first PCB and the second PCB are electrically connected via the first contactor bus-bars and the second contactor bus-bars.

Another example embodiment of these techniques is a power converter comprising an inductor including a toroidal core with a central hole configured to receive a rod, a wire wound around the toroidal core, and a thermally conductive potting encapsulating the wire to define a cylindrical potted body of the inductor with a bottom surface and a top surface opposite the bottom surface. The power converter further comprises a heatsink adjacent to the bottom surface of the cylindrical potted body, where the rod presses the potted body against the heatsink.

### BRIEF DESCRIPTION OF THE DRAWINGS

FIG. 1A is a block diagram of an example charging site at which multiple vehicle charging systems, or simply “chargers,” are configured for energy management using a direct current (DC) DC bus;

FIG. 1B is a block diagram of an example electric vehicle charging system configured for DC charge transfer;

FIGS. 2A and 2B are block diagrams of example charging site configured for energy management between multiple vehicle charging systems via a local AC circuit;

FIG. 2C is a block diagram of an example electric vehicle charging system configured for AC charge transfer;

FIG. 3 is a block diagram of an example combined electric vehicle charging system configured for both AC and DC charge transfer;

FIG. 4 is a block diagram of example hardware implementation of a controller that can operate in a system of FIG. 1A-3;

FIGS. 5A and 5B illustrate a power board configured to host four phases of a DC-to-DC converter, and two surface mount bars of this disclosure on the surface of the power board;

FIG. 6 schematically illustrates the topology of the power board of FIGS. 5A and 5B;

FIG. 7 is a perspective view of the power board of FIGS. 5A and 5B electrically coupled to a contactor board;

FIG. 8 is another perspective view of the power board of FIGS. 5A and 5B electrically coupled to a contactor board in accordance with the present disclosure;

FIG. 9 is an enlarged view of the electrical connection between the power board and the circuit board of FIGS. 7 and 8;

FIG. 10 is a perspective view of a power converter that be mounted on the power board of FIGS. 5A and 5B, to implement a phase of a DC-to-DC converter;

FIG. 11 is a cross-sectional view of the converter of FIG. 10; and

FIG. 12 is a cross-sectional view of the converter of FIG. 10 pressed against a heatsink.

### DETAILED DESCRIPTION

A low-resistance conductive bus bar is mounted on a printed circuit board (PCB) to provide equal distribution of high current to multiple components. These components can include DC-to-DC converters. The bus bar can be shaped as rectangular cuboid or a parallelepiped, but in any case with a relatively large cross-section to reduce electrical resistance. The bus bar is mounted onto the power board and soldered the PCB board by using a soldering surface mount process, for example. One bus bar can operate as an input bus bar, and another bus bar can operate as an output bus-bar. Generally speaking, the low-resistance bus bar is a low-cost component that does not require complicated manufacturing processes.

When the power board includes multiple parallel circuits such as DC-to-DC converters, the bus bars provide a substantially equal and low resistance path for the multiple parallel circuits on the board, without creating separate input and output connectors for each individual power circuit.

In some implementations, a heavy bus bar is soldered onto a contactor board using soldering through hole reflow process. The bus bars provide both electrical and mechanical support in an assembly including a contactor board and one or more PCBs with power distribution components. This configuration results in high-density power distribution between the power boards. This approach eliminates the need for a harness and cabling.

Further, the charging station can include common port design that supports both the CHAdeMO and CCS charging protocols. A module can be simply replaced with a jumper. This allows one to pull out a module and replace the module with a jumper.

Still further, an EV charger of this disclosure can utilize an inductor manufactured using a potting compound to encapsulate the wire wound around a core, to enhance thermal cooling through the heatsink. The indicator can be a toroid. The inductor has an inner aluminum rod that presses the potted body against the heatsink, so that there is pressure on the inductor applied in the direction the heatsink, for better cooling. In one particular implementation, the potting method confines the wire at the top of the inductor and at the bottom of the inductor into a thin “ironed layer” to create a thin high copper fill area. The fill factor can be 80% for example. This lowers the thermal conductivity from the core to the bottom surface of the inductor against the heatsink. Still further, potting provides electrical isolation, so that no live wires are exposed. More generally, these techniques improve both the size and power density of an inductor, reduce the amount of material used at the top and the bottom of the inductor, and reduce the thermally conductive path.

### System Architecture

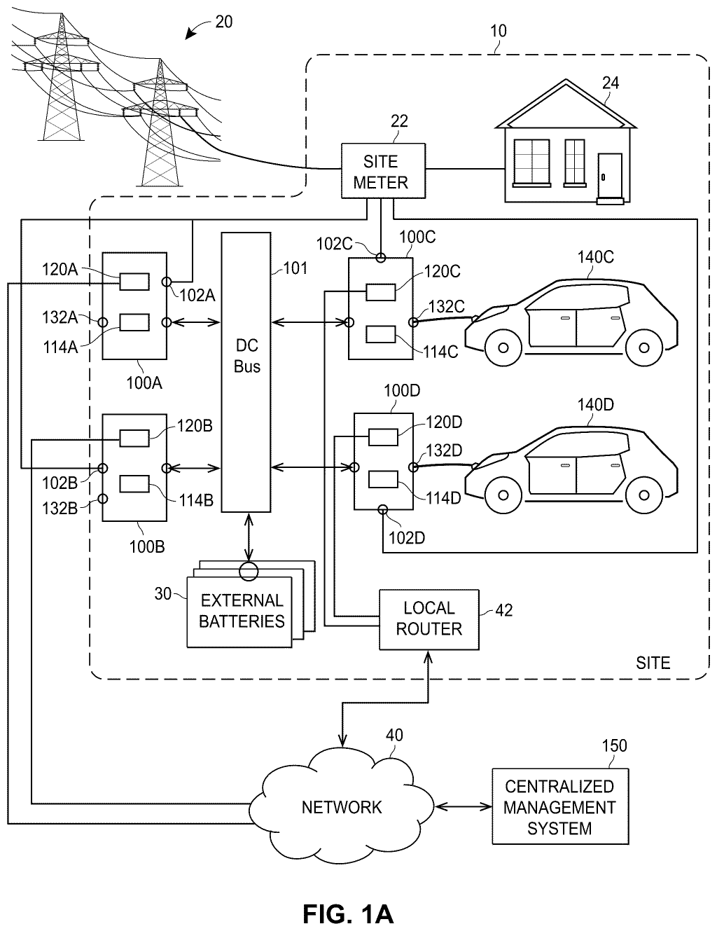

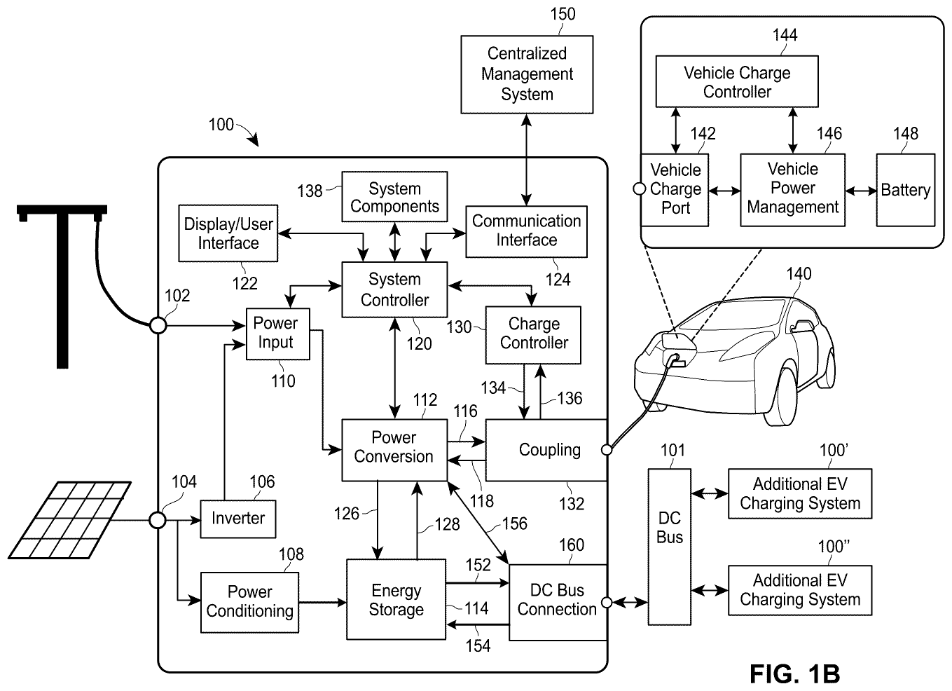

FIG. 1A illustrates a block diagram of an example of a charging site 10 configured for energy management between multiple EV charging systems 100A-D via a DC bus 101. The charging site 10 is supplied with AC power from an electric power grid 20 via a site meter 22, which records power consumption and connects the various electrical components disposed at the charging site 10 to the electric power grid 20. Thus, the electric power grid 20 provides AC power to each of the EV charging systems 100A-D and other electrical components via the site meter 22, including providing AC power to a non-charging load 24 (e.g., commercial building electrical infrastructure) at the charging site 10. In some embodiments, the site meter 22 is a smart meter including additional control logic and communication functionality. For example, the site meter 22 may be configured to communicate with one or more external servers (not show) and/or the centralized management system 150 to obtain demand data regarding load on or demand charges for AC power from the electric power grid 20. In some such embodiments, the site meter 22 may be configured to disconnect part or all of the loads from the electric power grid 20 upon the occurrence of certain conditions (e.g., during peak hours or when the power grid is unstable due to high demand). In this way, the site meter 22 may be used to separate the charging site 10 from the electric power grid 20 when needed. Although only one site meter 22 is shown, some embodiments may include a plurality of meters, each of which may perform part or all of the operation of the site meter 22. Such embodiments may be implemented to facilitate more targeted control of operations of individual EV charging systems 100 or non-charging loads 24 at the charging site 10.

The AC power from the site meter 22 is provided as an input AC electric power to the respective input ports 102A-D of the EV charging systems 100A-D via one or more wired AC connections. In some embodiments, the input AC electric power is received at each of the input ports 102A-D as a 120V or 240V single-phase or three-phase AC power supply. As discussed elsewhere herein, each of the EV charging systems 100A-D converts and stores such input AC electric power to DC power stored in batteries of respective energy storage modules 114A-D, from which charging currents may be provided to vehicles via vehicle couplings 132A-D of the EV charging systems 100A-D. The EV charging systems 100A-D are controlled by respective system controllers 120A-D, which monitor operating data of the respective EV charging systems 100A-D and control charging and discharging of the energy storage modules 114A-D.

In some embodiments, the DC power may be stored in the energy storage modules 114A-D over an interval of time in order to provide charging current to EVs via respective vehicle couplings 132A-D at a faster rate than the input AC electric power is received by the EV charging systems 100A-D. While this has significant advantages in reducing the electrical infrastructure requirements for the charging site 10, some of the EV charging systems 100A-D may be used more than others. For example, EV charging systems 100C and 100D may experience greater use due to closer proximity to a destination (e.g., by being located in a parking lot at locations nearer an entrance to a commercial building). As illustrated, vehicles 140C and 140D may be connected to EV charging systems 100C and 100D by vehicle couplings 132C and 132D, respectively, in order to receive charging currents from energy stored in the energy storage modules 114C and 114D, while no vehicles are charging at EV charging systems 100A and 100B. Thus, the batteries of EV charging systems 100C and 100D will discharge faster than those of EV charging systems 100A and 100B, resulting in a charge imbalance among the energy storage modules 114A-D. To address such an imbalance, energy may be transferred from EV charging systems 100A and 100B to EV charging systems 100C and 100D via the DC bus 101.

The DC bus 101 provides a direct DC power connection between the EV charging systems 100A-D to enable charge transfers among the energy storage modules 114A-D. Each of the EV charging systems 100A-D includes an inter-charger connection (not shown) that provides a bidirectional DC connection to the DC bus 101, and thereby to each of the other EV charging systems 100A-D. Through such inter-charger connections, the EV charging systems 100A-D are enabled to receive and to provide DC current at various times as part of charge transfers, which may be used to perform charge balancing between the energy storage modules 114A-D. In some embodiments, one or more external batteries 30 are also connected to the DC bus 101 to store energy received from the EV charging systems 100A-D and provide the stored energy at a later time, as needed. Such external batteries 30 may include controllers (not shown) to control charging and discharging, or the external batteries 30 may be controlled by the system controllers 120A-D of the EV charging systems 100A-D or by a centralized management system 150. Similarly, in various embodiments, charge transfers may be determined and controlled by the system controllers 120A-D of the EV charging systems 100A-D or by a centralized management system 150. To facilitate such control decisions, each of the system controllers 120A-D is connected via wired or wireless communication connections with the other system controllers 120A-D and/or with the centralized management system 150 to exchange electronic messages or signals.

The centralized management system 150 may communicate with each of the EV charging systems 100A-D in order to monitor operating data regarding the EV charging systems 100A-D and to determine and control charge transfers as needed. The centralized management system 150 may be located at the charging site 10 or at a location remote from the charging site 10. When remote from the charging site 10, the centralized management system 150 may be communicatively connected to the EV charging systems 100A-D via a network 40, which may be a proprietary network, a secure public internet, a virtual private network, or some other type of network, such as dedicated access lines, plain ordinary telephone lines, satellite links, cellular data networks, or combinations of these. In various embodiments, the EV charging systems 100A-D may be communicatively connected with the network 40 directly or via a local router 42. In some embodiments in which the centralized management system 150 is located at the charging site 10, the centralized management system 150 may be combined with or incorporated within any of the EV charging systems 100A-D. In still further embodiments, the centralized management system 150 may be configured as a local cloud or server group distributed across the system controllers 120A-D of the EV charging systems 100A-D in order to provide robust control in the event of a network disruption.

In some embodiments, the centralized management system 150 may also communicate with remote EV charging systems that are deployed in locations remote from the charging site 10, which locations may be separated by large geographic distances. For example, the centralized management system 150 may communicate with EV charging systems 100 located in different parking facilities, on different floors of the same parking structure, or in different cities. Such centralized management system 150 may comprise one or more servers configured to receive operating data from and to send data and/or control commands to each of the EV charging systems 100A-D. To facilitate communication, the centralized management system 150 may be communicatively connected to the system controllers 120A-D of the EV charging systems 100A-D via an electronic communication link with a communication interface module (not shown) within each of the EV charging systems 100A-D.

The centralized management system 150 may group or relate EV charging systems according to their location, their intended function, availability, operating status, and capabilities. The centralized management system 150 may remotely configure and control the EV charging systems, including the EV charging systems 100A-D. The centralized management system 150 may remotely enforce regulations or requirements governing the operation of the EV charging systems 100A-D. The centralized management system 150 may remotely interact with users of the EV charging systems 100A-D. The centralized management system 150 may remotely manage billing, maintenance, and error detection for each of the EV charging systems 100A-D. For example, error conditions resulting in manual disconnection of a vehicle from any of the EV charging systems 100A-D may be reported by such EV charging system to the centralized management system 150 for analysis. The centralized management system 150 may also communicate with mobile communication devices of users of the EV charging systems 100A-D, such as mobile communication devices or other computing devices used by operators of the EV charging systems 100A-D to enable the operator to self-configure the EV charging systems 100A-D, charge pricing, language localization, currency localization, and so on. Operation of the centralized management system 150 in relation to charge transfers between the EV charging systems 100A-D is further described elsewhere herein.

FIG. 1B illustrates a block diagram of an example of an EV charging system 100 configured in accordance with certain aspects disclosed herein. The EV charging system 100 may be any of the EV charging systems 100A-D at the charging site 10 illustrated in FIG. 1A. The EV charging system 100 is configured to receive electric power from a power source (e.g., electric power grid 20) via an input port 102 or 104 in order to charge an energy storage module 114 (e.g., one or more batteries), from which the EV charging system 100 provides a charging current to a vehicle 140 in order to charge a battery 148 of the vehicle 140. Such charge is provided through a vehicle coupling 132, which may comprise a charging cable utilizing one or more standard connector types (e.g., Combined Charging System (CCS) or Charge de Move (CHaDEMO) connectors). In addition to being connected to one or more power sources via the input ports 102 or 104, the EV charging system 100 includes a DC bus connection 160 to the DC bus 101 at the charging site 10. Through the DC bus connection 160, the EV charging system 100 is configured to send DC power to one or more additional EV charging systems 100′ or 100″ and to receive DC power from such additional EV charging systems 100′ or 100″, as controlled by a system controller 120 of the EV charging system 100. Although the illustrated EV charging system 100 is illustrated as communicating with a centralized management system 150, alternative embodiments of the EV charging system 100 need not be configured for such external communication. Additional or alternative components and functionality may be included in further alternative embodiments of charging systems.

The EV charging system 100 includes a power input module 110 having one or more circuits configurable to transform, condition, or otherwise modify power received from an input port 102 or 104 to provide conditioned power to a power conversion module 112. The input power received at input ports 102 or 104 may be received from an electric power grid 20, a local power generator (e.g., a solar panel or a wind turbine), or any other power source. In some embodiments, input AC power is received at an AC input port 102, while input DC power is received at a DC input port 104 (e.g., from photovoltaic cells or other types of DC power sources). The DC input port 104 may be connected to one or more of an inverter module 106 or a power conditioning module 108 for the input DC power. In further embodiments, DC current received via DC input port 104 is converted to an AC current by an inverter module 106, and the AC current is then provided to power input module 110. The power input module 110 may combine AC or DC current received from multiple sources. Similarly, the power input module 110 may direct AC or DC current received from multiple sources to individual circuits or sections of the power conversion module 112. In some embodiments, the power input module 110 may include a rectifier to convert AC current received at an input port 102 or 104 into DC current to be provided to the power conversion module 112. In further embodiments, DC current received via DC input port 104 may instead be provided to a power conditioning module 108 that may include voltage level converting circuits, filters, and other conditioning circuits to provide a charging current to the energy storage module 114.

The power conversion module 112 includes some combination of one or more AC-to-DC, DC-to-DC, and/or DC-to-AC converters for efficient conversion of AC or DC input power received from a power utility or other source at input port 102 or 104 via the power input module 110 to a DC energy storage current 126 provided to the energy storage module 114, which stores the power until needed to provide a charging current 116 to a vehicle 140. In some embodiments, the power conversion module 112 includes an AC-to-DC conversion circuit that generates a DC energy storage current 126 that is provided to an energy storage module 114. Alternatively, the power input module 110 may include an AC-to-DC conversion circuit to generate a DC current from an input AC electric power. In further embodiments, the energy storage module 114 includes high-capacity batteries that have a storage capacity greater than a multiple of the storage capacity in the EVs to be charged (e.g., three times, five times, or ten times an expected vehicle battery capacity). The storage capacity of the energy storage module 114 may be configured based on the expected average charge per charging event, which may depend upon factors such as the types of vehicles charged, the depletion level of the vehicle batteries when charging starts, and the duration of each charging event. For example, a retail parking site may have more charging events of shorter duration, while a commuter train parking lot may have fewer charging events of longer duration. In various embodiments, the storage capacity of the energy storage module 114 may be configured based on maximum expected charging offset by power received from an electric utility. In some embodiments, the storage capacity of each of the energy storage modules 114 of the EV charging systems 100 and any external batteries 30 at a charging site 10 may be configured to ensure a total charge stored at the charging site 10 is sufficient for an expected maximum load due to vehicle charging. In further embodiments, the power received from an electric utility may be limited to power available during low-demand times, such as off-peak or low-priced periods of the day. The power input module 110 may be configured to block or disconnect inflows of power during peak or high-priced periods of the day. In some embodiments, the power input module 110 may be configured to enable power reception during peak periods to ensure continued operation of the EV charging system 100 when power levels in the energy storage module 114 are unexpectedly low.

In some embodiments, the power conversion module 112 may include one or more DC-to-DC conversion circuits that receive DC current 128 at a first voltage level from the energy storage module 114 and drive a charging current 116 to a vehicle 140 through a vehicle coupling 132 to supply a vehicle 140 with the charging current 116 via a vehicle charge port 142. The vehicle coupling 132 serves as an electrical interconnect between the EV charging system 100 and the vehicle 140. In various embodiments, such vehicle coupling 132 comprises a charging head and/or a charging cable. For example, the vehicle coupling 132 may comprise a charging cable having a standard-compliant plug for connection with a vehicle charge port 142 of vehicles 140. The vehicle coupling 132 may include both a power connection for carrying the charging current 116 and a communication connection for carrying electronic communication between the charge controller 130 and the vehicle 140. In some embodiments, the EV charging system 100 may comprise multiple vehicle couplings 132, and the power conversion module 112 may include a corresponding number of DC-to-DC conversion circuits specific to each of the multiple couplings. According to some embodiments, the power conversion module 112 may be further configured to receive a reverse current 118 from a vehicle 140 via the vehicle coupling 132, which reverse current 118 may be used to provide a DC energy storage current 126 to add energy to the energy storage module 114. In some examples, the power conversion module 112 includes one or more inverters that convert the DC current 128 to an AC current that can be provided as the charging current 116.

A charge controller 130 controls the charging current 116 and/or reverse current 118 through each vehicle coupling 132. To control charging or discharging of the vehicle 140, the charge controller 130 comprises one or more logic circuits (e.g., general or special-purpose processors) configured to execute charging control logic to manage charging sessions with vehicle 140. Thus, the charge controller 130 is configured to communicate with the system controller 120 to control the power conversion module 112 to provide the charging current 116 to the vehicle 140 or to receive the reverse current 118 from the vehicle 140 via the vehicle coupling 132. In some instances, the charge controller 130 may include power control circuits that further modify or control the voltage level of the charging current 116 passed through the vehicle coupling 132 to the vehicle 140. The charge controller 130 also communicates via the vehicle coupling 132 with a vehicle charge controller 144 within the vehicle 140 to manage vehicle charging. Thus, the charge controller 130 communicates with the vehicle charge controller 144 to establish, control, and terminate charging sessions according to EV charging protocols (e.g., CCS or CHaDEMO). The charge controller 130 may be communicatively connected with the vehicle coupling 132 to provide output signals 134 to the vehicle charge controller 144 and to receive input signals 136 from the vehicle charge controller 144.

A system controller 120 is configured to control operations of the EV charging system 100 by implementing control logic using one or more general or special-purpose processors. The system controller 120 is configured to monitor and control power levels received by the power input module 110, power levels output through the charging current 116, energy levels in the energy storage module 114, and charge received from or output to the DC bus 101 via the DC bus connection 160. The system controller 120 is further configured to communicate with and control each of the one or more charge controllers 130, as well as controlling the power conversion module 112. For example, the system controller 120 is configured to control the power conversion module 112 and the charge controller to supply a charging current 116 to the vehicle coupling 132 in response to instructions from the charge controller 130. As discussed further herein, the system controller 120 is also configured to control (either separately or in coordination with the centralized management system 150) charge transfers to manage energy levels of the EV charging system 100 in relation to additional EV charging systems 100′ and 100″ at the charging site 10.

The system controller 120 controls charge transfers by determining occurrence of a triggering condition for a charge transfer and controlling a response to such triggering condition in order to provide or receive DC power via a direct connection with one or more additional EV charging systems 100′ or 100″ provided by the DC bus 101. Thus, the system controller 120 controls receiving DC input from and providing DC output to the DC bus 101 via a DC bus connection 160 of the EV charging system 100 in order to effect charge transfers at the charging site 10. The DC bus connection 160 serves as an inter-charger connection of the EV charging system 100 and is configured to connect the EV charging system 100 to the DC bus 101 at the charging site 10 as a direct connection for the exchange of DC power between the EV charging system 100 and additional EV charging systems 100′ and 100″ (e.g., other EV charging systems of the EV charging systems 100A-D) at the charging site 10, as well as with any external batteries 30 at the site 10 (as illustrated in FIG. 1A). In some embodiments, the DC bus connection 160 receives and provides DC power via a DC link 156 with the power conversion module 112, with the power conversion module 112 being controlled by the system controller 120 to manage any voltage or current requirements of the energy storage module 114 or the DC bus 101. In additional or alternative embodiments, the DC bus connection 160 may directly interface with the energy storage module 114 in order to provide a DC output current 152 from the energy storage module 114 to the DC bus 101 and to provide a DC input current 154 from the DC bus 101 to the energy storage module 114, as controlled by the system controller 120.

The system controller 120 is also configured to communicate with other various system components 138 of the EV charging system 100 (e.g., other controllers or sensors coupled to the energy storage module 114 or other components of the EV charging system 100) in order to receive operating data and to control operation of the system via operation of such system components 138. For example, the system controller 120 may monitor temperatures within the EV charging system 100 using the system components 138 and may be further configured to mitigate increases in temperature through active cooling or power reductions using the same or different system components 138. Likewise, the system controller 120 communicates with a user interface module 122 (e.g., a touchscreen display) and a communication interface module 124 (e.g., a network interface controller) to provide information and receive control commands. Each communication interface module 124 may be configured to send and receive electronic messages via wired or wireless data connections, which may include portions of one or more digital communication networks.

The system controller 120 is configured to communicate with the components of the EV charging system 100, including power input module 110, power conversion module 112, the user interface module 122, the communication interface module 124, the charge controller 130, and the system components 138 over one or more data communication links. The system controller 120 may also be configured to communicate with external devices, including a vehicle 140 via the vehicle coupling 132, one or more additional EV charging systems 100′ and 100″ via the centralized management system 150, one or more external batteries 30, or a site meter 22. The system controller 120 may manage, implement or support one or more data communication protocols used to control communication over the various communication links, including wireless communication or communication via a local router 42. The data communication protocols may be defined by industry standards bodies or may be proprietary protocols.

The user interface module 122 is configured to present information related to the operation of the EV charging system 100 to a user and to receive user input. The user interface module 122 may include or be coupled to a display with capabilities that reflect intended use of the EV charging system 100. In one example, a touchscreen may be provided to present details of charging status and user instructions, including instructions describing the method of connecting and disconnecting a vehicle 140. The user interface module 122 may include or be coupled to a touchscreen that interacts with the system controller 120 to provide additional information or advertising. The system controller 120 may include or be coupled to a wireless communication interface that can be used to deliver a wide variety of content to users of the EV charging system 100, including advertisements, news, point-of-sale content for products/services that can be purchased through the user interface module 122. The display system may be customized to match commercial branding of the operator, to accommodate language options and for other purposes. The user interface module 122 may include or be connected to various input components, including touchscreen displays, physical input mechanisms, identity card readers, touchless credit card readers, and other components that interact through direct connections or wireless communications. The user interface module 122 may further support user authentication protocols and may include or be coupled to biometric input devices such as fingerprint scanners, iris scanners, facial recognition systems and the like.

In some embodiments, the energy storage module 114 is provisioned with a large battery pack, and the system controller 120 executes software to manage input received from a power source to the battery pack based upon demand level data (e.g., demand or load data from an electric power grid 20 or site meter 22), such that power is drawn from the power source to charge the battery pack at low-load time periods and to avoid drawing power from the grid during peak-load hours. The software may be further configured to manage power output to provide full, fast charging power in accordance with usage generated by monitoring patterns of usage by the EV charging system 100. The use of historical information can avoid situations in which the battery pack becomes fully discharged or depleted beyond a minimum energy threshold. For example, charging may be limited at a first time based upon a predicted later demand at a second time, which later demand may be predicted using historical information. This may spread limited charging capacity more evenly among vehicle throughout the course of a day or in other situations in which battery pack capacity is expected to be insufficient to fully charge all EVs over a time interval, taking account of the ability to add charge to the energy storage module 114.

In further embodiments, the system controller 120 executes software (either separately or in coordination with the centralized management system 150) to manage energy draw and use by controlling charging and discharging over time among multiple EV charging systems 100 at the charging site 10. Thus, the charge drawn from the power source may be limited or avoided during peak-load hours by charge transfer between the EV charging system 100 and one or more additional EV charging systems 100′ and 100″ via the DC bus 101 at the charging site 10, effectively pooling the energy stored in the batteries of all of the charging systems at the charging site 10. As noted above, in some embodiments, the charging site 10 may include one or more external batteries 30 connected to the DC bus 101. In such embodiments, the systems controller 120 and/or the centralized management system 150 may further manage energy inflow and outflow at the charging site 10 by controlling selective charging and discharging such batteries at appropriate time periods to avoid or reduce total power draw of the charging site 10 from the power source during peak-demand or other high-demand times by charging the batteries of the EV charging systems 100 and the external batteries 30 during low-demand times. In some such embodiments, such energy management enables the EV charging system 100 to continue charging vehicles 140 even when the power source is disconnected or unavailable (e.g., when a local power grid is down). As discussed further elsewhere herein, the systems controllers 120 of the EV charging systems 100 and/or the centralized management system 150 may further manage site-wide energy use by controlling charge transfers based upon differential charge levels or discharge levels associated with differential utilization of the various EV charging system 100 at the charging site 10 in order to effect charge balancing or to ensure sufficient charge availability for charging vehicle 140 at one or more of the EV charging systems 100.

In some embodiments, the EV charging system 100 may be configured with two or more vehicle couplings 132 to enable concurrent charging of multiple vehicles 140. The system controller 120 may be configured by a user via the user interface module 122 to support multiple modes of operation and may define procedures for charge transfer or power distribution that preserve energy levels in the energy storage module 114 when multiple vehicles 140 are being concurrently charged. Charge transfers may be used to transfer power from EV charging systems 100 that have available power or are not being used to charge a vehicle 140 to EV charging systems 100 that are charging one or more vehicles 140. Distribution of power may be configured to enable fast charging of one or more vehicles 140 at the expense of other vehicles 140. In this regard, the vehicle couplings 132 may be prioritized or the system controller 120 may be capable of identifying and prioritizing connected vehicles 140. In some instances, the system controller 120 may be configured to automatically control the respective charge controllers 130 to split available power between two vehicles 140 after the second vehicle 140 is connected. The available power may be evenly split between two vehicles 140 or may be split according to priorities or capabilities. In some examples, the system controller 120 may conduct arbitration or negotiation between connected vehicles 140 to determine a split of charging capacity. A vehicle 140 may request a charging power level at any given moment based on temperature, battery charge level, and other characteristics of the vehicle 140 and its environment and to achieve maximum charge rate and minimum charging time for the current circumstances.

As illustrated, a vehicle 140 may be charged by connecting the vehicle 140 to the EV charging system 100 via a vehicle coupling 132. This may include plugging a charging cable of the EV charging system 100 into a vehicle charge port 142 of the vehicle 140. The vehicle charge port 142 is configured to receive the charging current 116 through the vehicle coupling 132 and provide such received current to a vehicle power management module 146. The vehicle charge port 142 is further configured to provide an electronic communication connection between the vehicle coupling 132 and a vehicle charge controller 144, which controls charging of the vehicle 140. The vehicle power management module 146 is controlled by the vehicle charge controller 144 to provide power to each of one or more batteries 148 of the vehicle 140 in order to charge such battery 148. In some instances, the vehicle charge port 142 includes a locking mechanism to engage and retain a portion of the vehicle coupling 132 in place during charging sessions. For example, for safety reasons, the vehicle charge controller 144 may control a locking mechanism of the vehicle charge port 142 to lock a plug of a charging cable in the vehicle charge port 142 while a charging session is active.

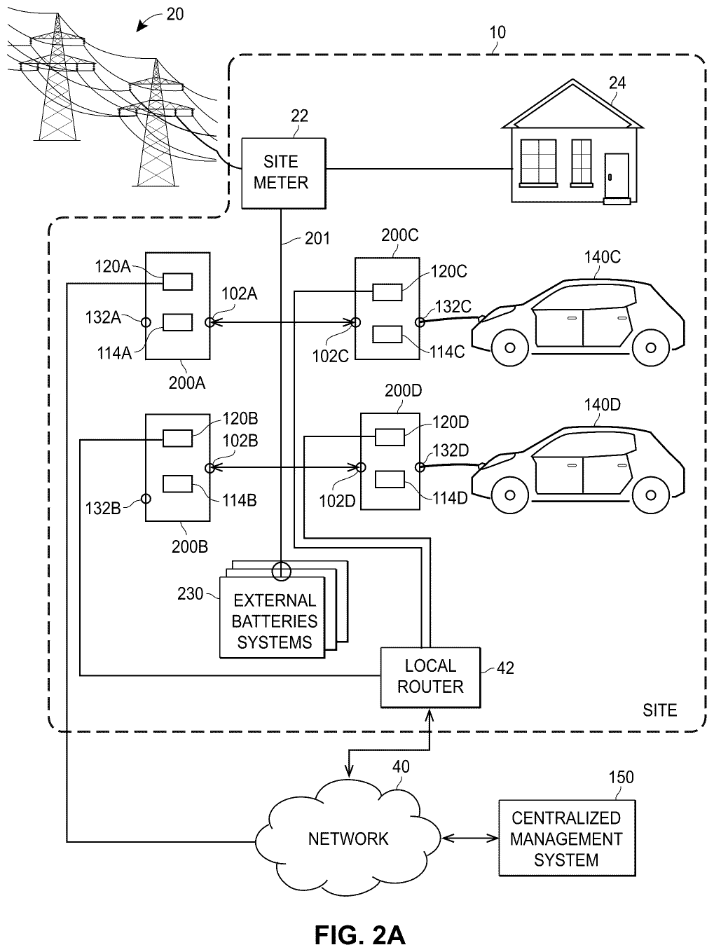

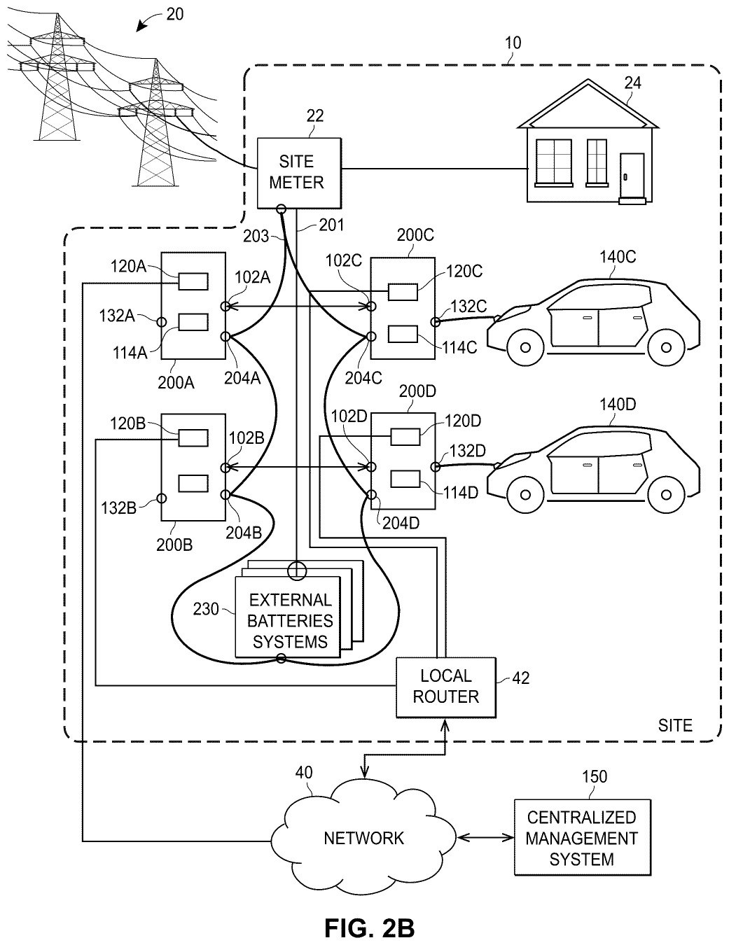

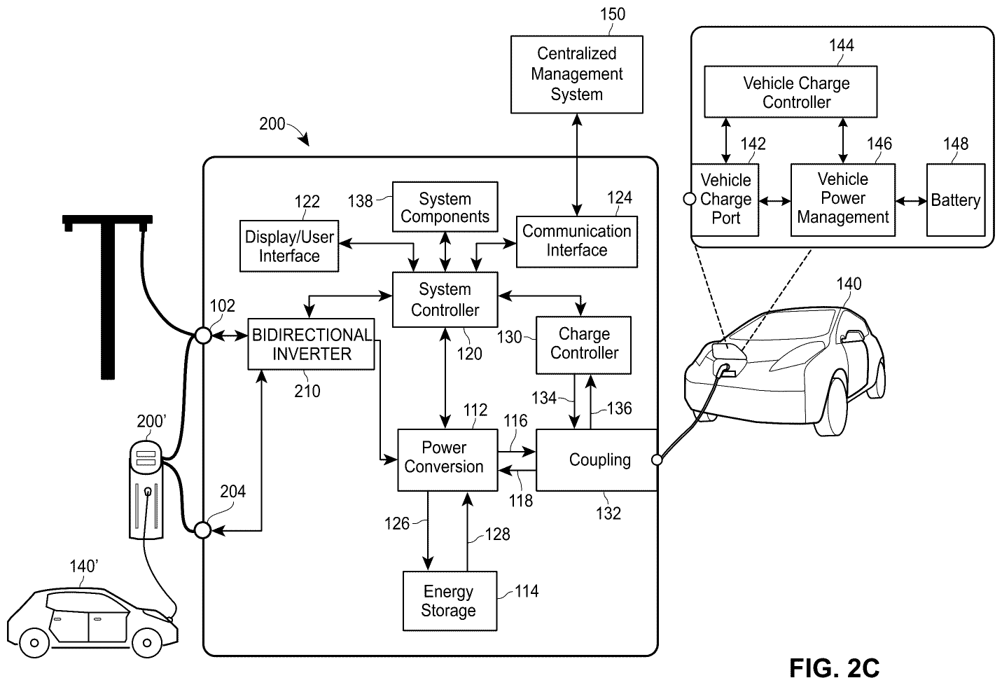

FIGS. 2A-B illustrate block diagrams of examples of a charging site 10 configured for energy management between multiple EV charging systems 200A-D via a local AC circuit 201 or 203. The configurations of the systems and components shown in FIGS. 2A-B are similar to those shown in FIG. 1A, but the EV charging systems 200A-D are configured and connected to transfer charge as AC current over a local AC circuit 201 or 203, rather than as DC current over the DC bus 101. Accordingly, each of the EV charging systems 200A-D receives input AC electric power at respective input ports 102A-D from the electric power grid 20 via the site meter 22 and a local AC circuit 201. The EV charging systems 200A-D rectify the input AC electric power into DC electric power to charge batteries of their respective energy storage modules 114A-D, which may then be used to provide charging currents to vehicles via vehicle couplings 132A-D (as shown with respect to vehicles 140C and 140D). The site meter 22 also provides AC power from the electric power grid 20 to the non-charging load 24 (e.g., commercial building electrical infrastructure) at the charging site 10. Operation of each of the EV charging systems 200A-D is controlled by their respective system controllers 120A-D, which are communicatively connected to the centralized management system 150, either directly or via the network 40, which may include a connection via a local router 42 at the charging site 10.

As discussed elsewhere herein, the EV charging systems 200A-D are configured and controlled by the system controllers 120A-D and/or the centralized management system 150 to transfer charge via local AC circuit 201 or 203 as needed to improve the balance of energy storage and energy demand at each of the EV charging systems 200A-D. To achieve such energy transfers, the DC power provided by one or more of the energy storage modules 114A-D is converted to an AC current by an inverter (not shown) and provided to the local AC circuit 201 or 203 in order to transfer energy to one or more other energy storage modules 114A-D. The respective system controllers 120A-D of the donor EV charging systems 200A-D may be configured to control the phase of the AC output power to the local AC circuit 201 or 203 to match that of the input AC electric power from the site meter 22 or of other donor EV charging systems 200A-D. As noted above, the input AC electric power may be received at each of the input ports 102A-D as a 120V or 240V single-phase or three-phase AC power supply. In various embodiments, the AC output power at input ports 102A-D or input ports 204A-D may be provided according to the same or different voltage and phase combinations.

FIG. 2A illustrates an embodiment in which one local AC circuit 201 carries both the input AC electric power from the electric power grid 20 via the site meter 22 and AC charge transferred between the EV charging systems 200A-D. In such embodiments, the respective input ports 102A-D serve to both receive AC current from the local AC circuit 201 and provide AC current to the local AC circuit 201. In some such embodiments, the local AC circuit 201 may be further connected to one or more non-charging loads 24 at the charging site 10 in order to provide AC power to such non-charging loads 24 when the electric power grid 20 is disconnected or unavailable.

FIG. 2B illustrates an embodiment in which a separate local AC circuit 203 carries AC current for energy transfers among the EV charging systems 200A-D, while the local AC circuit 201 carries the input AC electric power from the electric power grid 20. As illustrated, the local AC circuit 201 may be connected to each of the EV charging systems 200A-D via respective input ports 102A-D, while the local AC circuit 203 may be connected to each of the EV charging systems 200A-D via the respective input ports 204A-D. Such separation of the local AC circuits 201 and 203 may be advantageous in some situations by enabling charge transfers at higher power than the input AC electric power from the electric power grid 20 or while such input AC electric power is being received from the electric power grid 20. In some embodiments, the local AC circuit 203 is also connected to the site meter 22. In some such embodiments, the site meter 22 may receive AC power from the local AC circuit 203 and provide such AC power to one or more non-charging loads 24 at the charging site 10 in order to provide AC power to such non-charging loads 24 when the electric power grid 20 is disconnected or unavailable.

In some embodiments, the local AC circuit 201 and/or 203 also connects one or more external battery systems 230 to the EV charging systems 200A-D in order to increase the storage capacity at the charging site 10. Such external battery systems 230 may receive input AC power from the electric power grid 20 via local AC circuit 201 and/or from the EV charging systems 200A-D via local AC circuit 203 in order to charge one or more batteries (not shown) of the external battery systems 230. Such external battery systems 230 may include various components (not shown), including controllers and bidirectional inverters or separate rectifiers and inverters in order to convert the input AC power into DC power for storage and later convert the stored DC power into output AC power for charge transfers to one or more of the EV charging systems 200A-D.

FIG. 2C illustrates a block diagram of an example of an EV charging system 200 configured in accordance with certain aspects disclosed herein. The EV charging system 200 may be any of the EV charging systems 200A-D at the charging site 10 illustrated in FIGS. 2A-B. The components and configuration of the EV charging system 200 shown in FIG. 2C are similar to those of the EV charging system 100 shown in FIG. 1B, but the EV charging system 200 is configured for transferring charge to an additional EV charging system 200′ as AC current over a local AC circuit 201 or 203 via one or more of the input ports 102 or 104, rather than as DC current over the DC bus 101 via the DC bus connection 160. Accordingly, the power input module 110 of EV charging system 100 is replaced with a bidirectional inverter 210, which is connected to provide DC power to the power conversion module 112 and is further connected to receive input AC power from and to provide output AC power to the input ports 102 and 204. As illustrated, the EV charging system 200 also lacks the inverter module 106 and power conditioning module 108 to receive input DC electrical energy from DC input port 104 of the EV charging system 100, but such components may be included in some embodiments of the EV charging system 200. Other components of the EV charging system 200 are as described above with respect to the EV charging system 100. Additional or alternative components and functionality may be included in further alternative embodiments of charging systems.

The bidirectional inverter 210 is configured to alternatively operate in an inverter mode or in a rectifier mode at various times as controlled by the system controller 120. In the rectifier mode, the bidirectional inverter 210 converts an input AC current from a power source (e.g., the electric power grid 20 or an additional EV charging system 200′ via a local AC circuit 201 or 203) into a DC current to provide to the energy storage module 114 via the power conversion module 112. In the inverter mode, the bidirectional inverter 210 convers a DC current from the energy storage module 114 via the power conversion module 112 into an output AC current to the local AC circuit 201 or 203 via an input port 102 or 204. Thus, when a triggering condition occurs to cause the EV charging system 200 to provide an AC output power to the local AC circuit 201 or 203 to transfer charge to an additional EV charging system 200′ at the charging site 10 (e.g., to enable the additional EV charging system 200′ to charge a vehicle 140′), the bidirectional inverter operates in the inverter mode to convert a DC current from the power conversion module 112 into the AC output power and provide such AC output power to the local AC circuit 201 or 203 via an input port 102 or 204. In some embodiments, a plurality of separate components may instead be configured to perform such functionality of the bidirectional inverter 210, such as by including one or more inverters and rectifiers in the EV charging system 200. In further embodiments, part or all of the functionality of the bidirectional inverter 210 may be incorporated into the power conversion module 112, or part or all of the functionality of the power conversion module 112 may be incorporated into the bidirectional inverter 210.

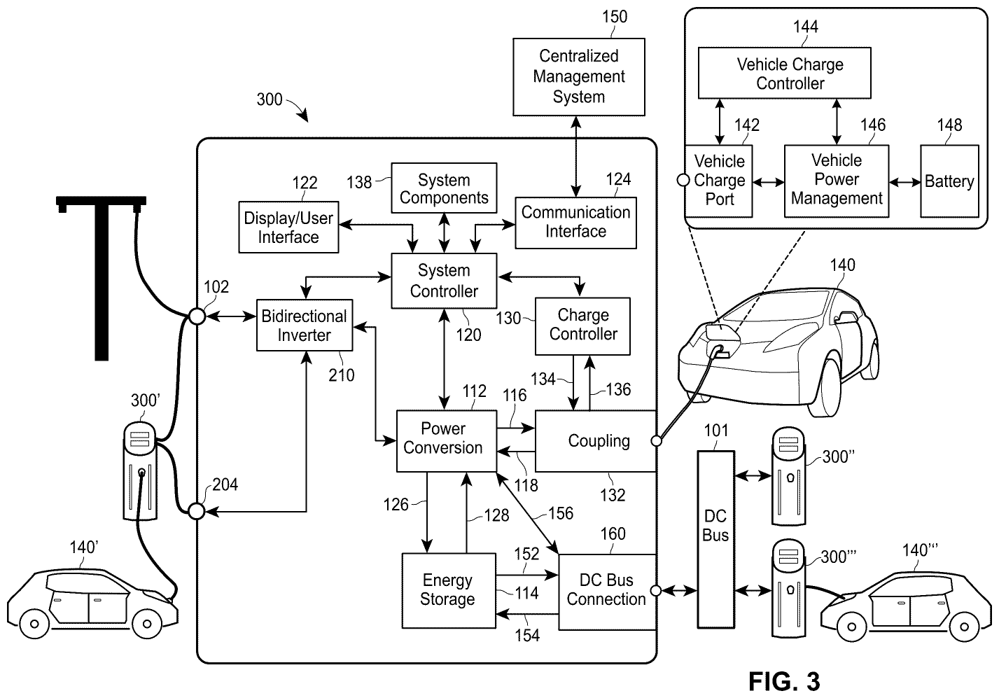

FIG. 3 illustrates a block diagram of an example of a combined EV charging system 300 configured for both AC and DC charge transfer in accordance with certain aspects disclosed herein. The EV charging system 300 may be any of the EV charging systems 100A-D or EV charging systems 200A-D at the charging sites 10 illustrated in FIG. 1A or FIGS. 2A-B. The components and configuration of the EV charging system 300 shown in FIG. 3 combine those of the EV charging system 100 shown in FIG. 1B and those of the EV charging system 200 shown in FIG. 2C. Thus, the EV charging system 300 is configured for transferring charge to additional EV charging system 300′ via a local AC circuit 201 or 203 (e.g., to enable the additional EV charging system 200′ to charge a vehicle 140′) and for transferring charge to additional EV charging systems 300″ and 300″′ via DC bus 101 (e.g., to enable the additional EV charging system 300″′ to charge a vehicle 140′″). As illustrated, the EV charging system 300 includes the bidirectional inverter 210 of EV charging system 200, rather than the power input module 110 of EV charging system 100. As further illustrated, the EV charging system 300 also lacks the inverter module 106 and power conditioning module 108 to receive input DC electrical energy from DC input port 104 of the EV charging system 100, but such components may be included in some embodiments of the EV charging system 300. Other components of the EV charging system 300 are as described above with respect to the EV charging system 100 or EV charging system 200. Additional or alternative components and functionality may be included in further alternative embodiments of charging systems.

### Example Controller

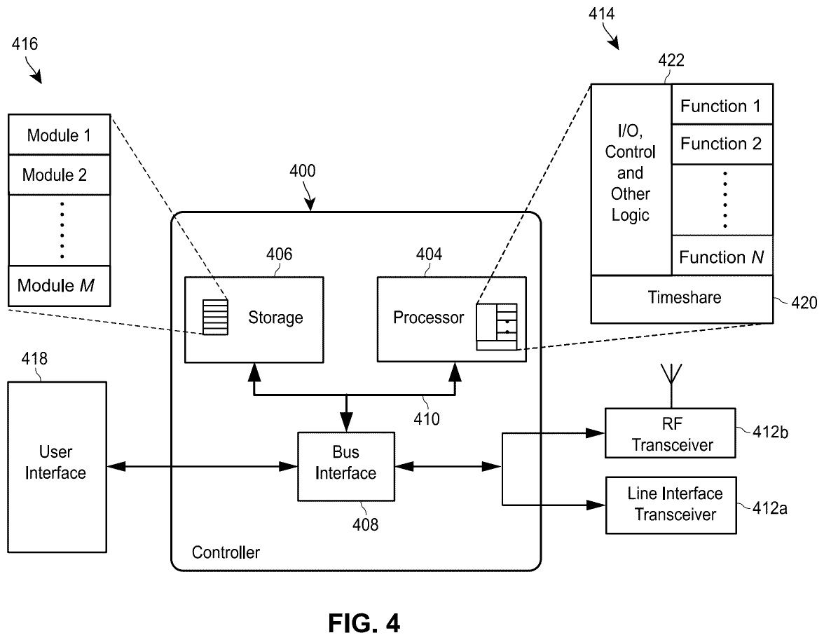

FIG. 4 illustrates a block diagram illustrating a simplified example of a hardware implementation of a controller 400, such as any of the system controller 120, the charge controller 130, the vehicle charge controller 144, or the centralized management system 150 disclosed herein. In some embodiments, the controller 400 may be a controller of a site meter 22, an external battery 30, an external battery system 230, or any other component disclosed herein that implements control logic to control any aspect of the described systems and methods. The controller 400 may include one or more processors 404 that are controlled by some combination of hardware and software modules. Examples of processors 404 include microprocessors, microcontrollers, digital signal processors (DSPs), application-specific integrated circuits (ASICs), field programmable gate arrays (FPGAs), programmable logic devices (PLDs), state machines, sequencers, gated logic, discrete hardware circuits, and other suitable hardware configured to perform the various functionality described throughout this disclosure. The one or more processors 404 may include specialized processors that perform specific functions, which may be configured by one or more of the software modules 416. The one or more processors 404 may be configured through a combination of software modules 416 loaded during initialization and may be further configured by loading or unloading one or more software modules 416 during operation.

In the illustrated example, the controller 400 may be implemented with a bus architecture, represented generally by the bus 410. The bus 410 may include any number of interconnecting buses and bridges depending on the specific application of the controller 400 and the overall design constraints. The bus 410 links together various circuits including the one or more processors 404 and storage 406. Storage 406 may include memory devices and mass storage devices, any of which may be referred to herein as computer-readable media. The bus 410 may also link various other circuits, such as timing sources, timers, peripherals, voltage regulators, and power management circuits. A bus interface 408 may provide an interface between the bus 410 and one or more line interface circuits 412, which may include a line interface transceiver circuit 412a and a radio frequency (RF) transceiver circuit 412b. A line interface transceiver circuit 412a may be provided for each networking technology supported by the controller. In some instances, multiple networking technologies may share some or all of the circuitry or processing modules found in a line interface circuit 412, such as line interface transceiver circuit 412a for wired communication and RF transceiver circuit 412b for wireless communication. Each line interface circuit 412 provides a means for communicating with various other devices over a transmission medium. In some embodiments, a user interface 418 (e.g., touchscreen display, keypad, speaker, or microphone) may also be provided, and may be communicatively coupled to the bus 410 directly or through the bus interface 408.

A processor 404 may be responsible for managing the bus 410 and for general processing that may include the execution of software stored in a computer-readable medium that may include the storage 406. In this respect, the processor 404 of the controller 400 may be used to implement any of the methods, functions, and techniques disclosed herein. The storage 406 may be used for storing data that is manipulated by the processor 404 when executing software, and the software may be configured to implement any of the methods disclosed herein.

One or more processors 404 in the controller 400 may execute software. Software may include instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 406 or in an external computer readable medium. The external computer-readable medium and/or storage 406 may include a non-transitory computer-readable medium. A non-transitory computer-readable medium includes, by way of example, a magnetic storage device (e.g., hard disk, floppy disk, magnetic strip), an optical disk, a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. Portions of the computer-readable medium or the storage 406 may reside in the controller 400 or external to the controller 400. The computer-readable medium and/or storage 406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 406 may maintain software maintained or organized in loadable code segments, modules, applications, programs, etc., which may be referred to herein as software modules 416. Each of the software modules 416 may include instructions and data that, when installed or loaded on the controller 400 and executed by the one or more processors 404, contribute to a run-time image 414 that controls the operation of the one or more processors 404. When executed, certain instructions may cause the controller 400 to perform functions in accordance with certain methods, algorithms, and processes described herein.

Some of the software modules 416 may be loaded during initialization of the controller 400, and these software modules 416 may configure the controller 400 to enable performance of the various functions disclosed herein. For example, some software modules 416 may configure internal devices or logic circuits 422 of the processor 404, and may manage access to external devices such as line interface circuits 412, the bus interface 408, the user interface 418, timers, mathematical coprocessors, etc. The software modules 416 may include a control program or an operating system that interacts with interrupt handlers and device drivers to control access to various resources provided by the controller 400. The resources may include memory, processing time, access to the line interface circuits 412, the user interface 418, etc.

One or more processors 404 of the controller 400 may be multifunctional, whereby some of the software modules 416 are loaded and configured to perform different functions or different instances of the same function. For example, the one or more processors 404 may additionally be adapted to manage background tasks initiated in response to inputs from the user interface 418, the line interface circuits 412, and device drivers. To support the performance of multiple functions, the one or more processors 404 may be configured to provide a multitasking environment, whereby each of a plurality of functions is implemented as a set of tasks serviced by the one or more processors 404 as needed or desired. In one example, the multitasking environment may be implemented using a timesharing program 420 that passes control of a processor 404 between different tasks, whereby each task returns control of the one or more processors 404 to the timesharing program 420 upon completion of any outstanding operations or in response to an input such as an interrupt. When a task has control of the one or more processors 404, the processing circuit is effectively specialized for the purposes addressed by the function associated with the controlling task. The timesharing program 420 may include an operating system, a main loop that transfers control on a round-robin basis, a function that allocates control of the one or more processors 404 in accordance with a prioritization of the functions, or an interrupt-driven main loop that responds to external events by providing control of the one or more processors 404 to a handling function.

### Surface Mount Bus Bar and Harness-Free Connection to a Contactor Board

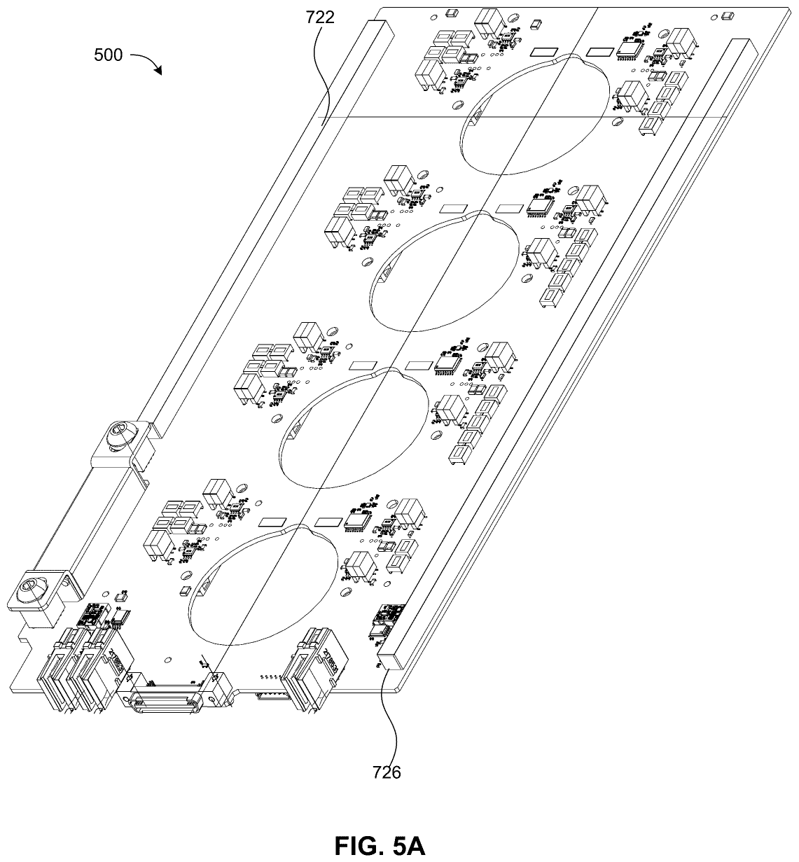

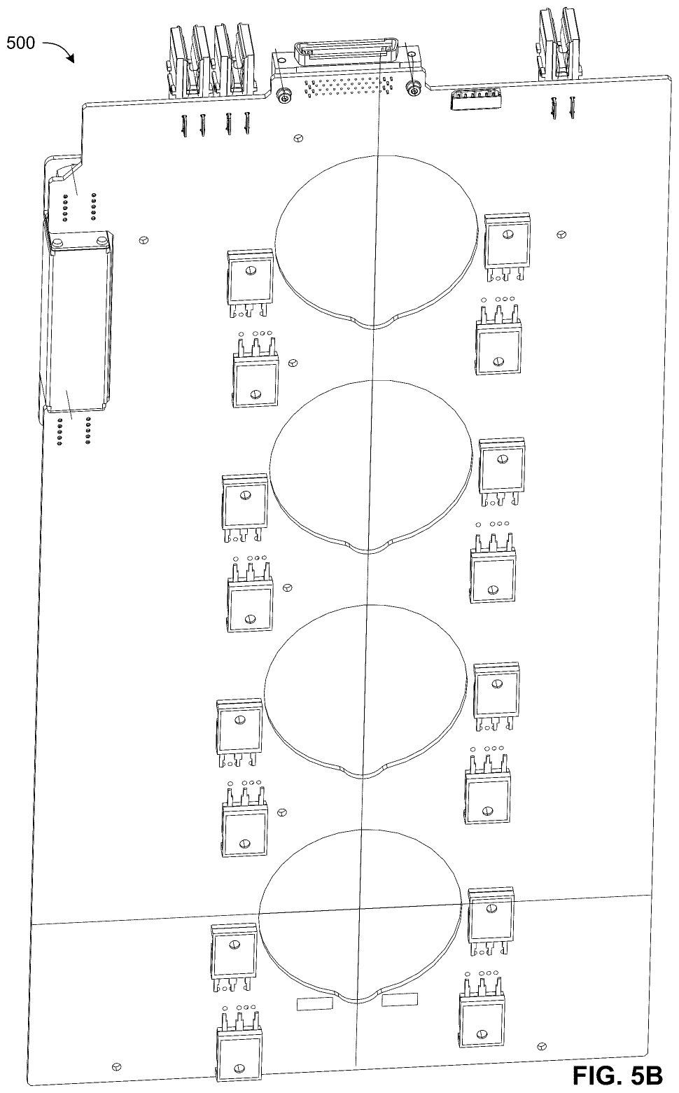

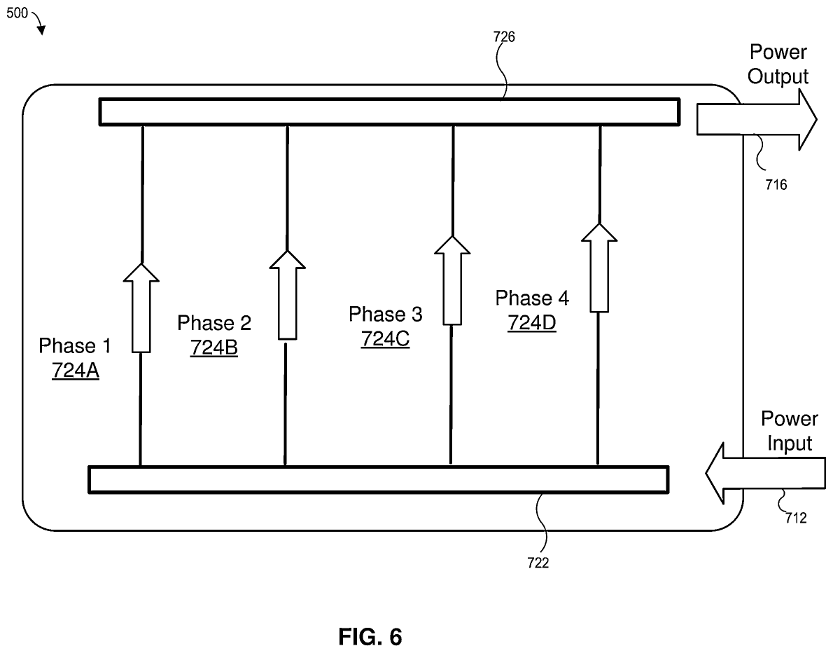

FIGS. 5A and 5B illustrate a printed circuit board (PCB) 500, referred to below as a power board 500, configured to host components that implement power conversion. In particular, the power board 500 in this example implementation is configured to support four phases of a multi-phase power conversion circuit, which can implement DC-to-DC conversion for example. Surface mount bars (or “bus bars”) 722 and 726, discussed further below, are mounted on the surface of the power board 500 to provide symmetrical and efficient power distribution to the multiple phases o of the power conversion circuit. The surface mount bars 722 and 726 are referred to below as low-resistance, conductive bus bars. FIG. 6 schematically illustrates the board of FIGS. 5A and 5B.

The power board 500 can operate in an EV charger such as the charging station discussed above. The low-resistance bus-bars 722 and 726 are soldered to the power board using a soldering surface mount reflow process

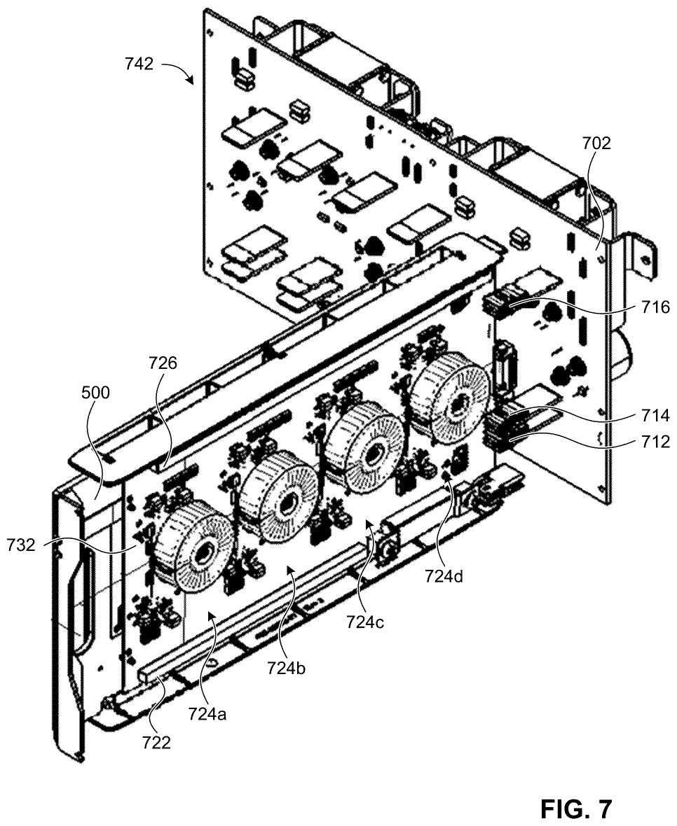

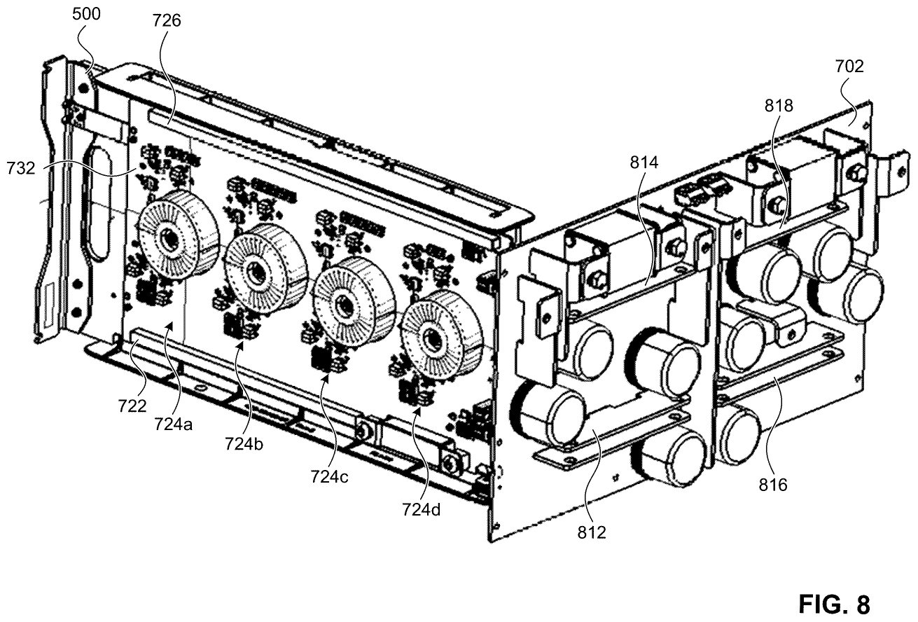

FIGS. 7, 8, and 9 illustrate perspective views of the power board 500 of FIGS. 5 and 5B electrically coupled to a contactor board 702. In the illustrated example, only one power board 500 is shown coupled to the contactor board 702; however, in general multiple power boards 500 can be coupled to the contactor board 702. Additionally, in some examples the contactor board 702 can be electrically coupled to similar or identical contactor boards coupled to power boards that are similar or identical to the power board 500. Additionally, the contactor board 702 and the power board 500 include various electric components, not discussed in detail herein, needed to transmit electric current and convert power.

The power board 500 includes a first power input electrical connection 712 and second power input electrical connection 714. Additionally, the power board 500 includes a power output electrical connection 716. The power input electrical connections 712, 714 pass electrical power through an input surface mount bus bar 722, through each of the first phase 724a, second phase 724b, third phase 724c, and fourth phase 724d, and through the output surface mount bus bar 726 to the power output electrical connection 716. The power board 500 includes circuit elements (shown in part) to electrically couple the first and second power input electrical connections 712, 714; input surface mount bus bar 722; first, second, third, and fourth phases 724a, 724b, 724c, 724d; the output surface mount bus bar 726, and the power output electrical connection 716.

The input and output surface mount bus bars 722, 726 are disposed on the surface 732 of the power board 500. The input and output surface mount bus bars 722, 726 are sized to reduce Joule heating (heat generating due to electrical resistance in a material). Additionally, the surface mount bus bars 722, 726 are exposed to expel heat through passive or forced convective heat transfer. In other examples, the surface mount bus bars 722, 726 could be differently sized to accommodate different electrical currents or could be manufactured with cooling fins to increase convective cooling capacity.

The contactor board 702 includes several electrical connector docks 742. Each of the connector docks 742 include electrical connections to engage the corresponding power input electrical connections 712, 714 and power output electrical connections 716. In the present example, the connector docks 742 are press fit into the power input electrical connections 712, 714 and power output electrical connections 716. In other examples, the connector docks 742 could be soldered or otherwise mechanically fastened to the power input electrical connections 712, 714 and power output electrical connections 716. In some examples, the connector docks 742 are in electrical communication with each other. For example, the circuit board 702 includes a first lateral electrical connection 812 to couple two or more first power input electrical connection 712 and second power input electrical connection 714. Additionally, the circuit board 702 includes a second lateral electrical connection 814 to couple two or more output power electrical connections 716. In various examples, the circuit board 702 may further include a third and fourth electrical connection 816, 818 to further electrical couple additional first and second power input electrical connections 712, 714 and power output electrical connections 716, respectively. As a result, the first, second, third, and fourth power output electrical connections 812, 814, 816, 818 can electrically couple two or more power boards 500.

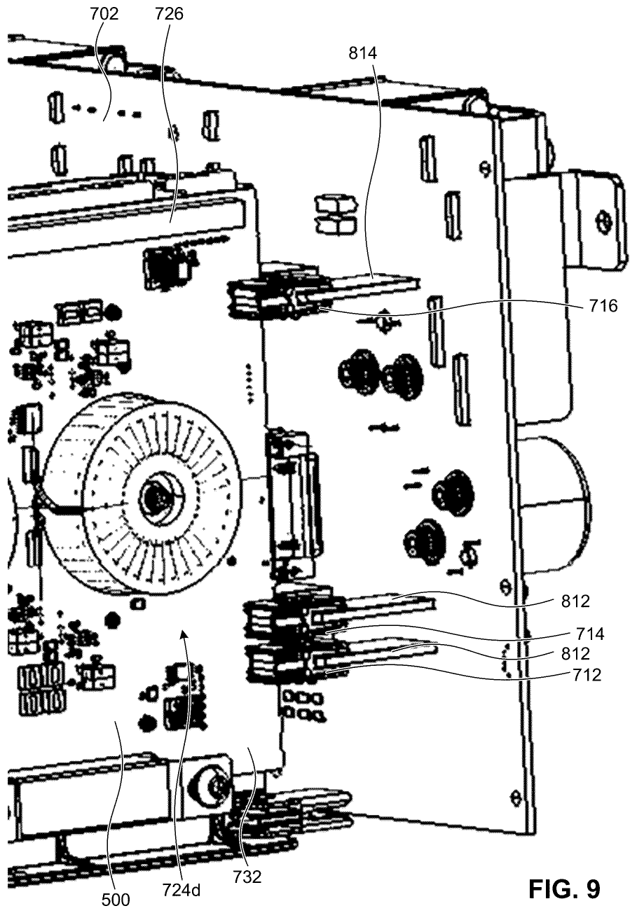

As shown in greater detail in FIG. 9, the first and second electrical connections 812, 814 pass through the circuit board 702 to couple to the first and second power input electrical connections 712, 714 and the power output electrical connection 716. In various examples, the first and second electrical connections 812, 814 can be coupled or mechanically fastened to the contactor board 702 via soldering, mechanical fastener, press-fit connection, or any other manner of coupling the first and second electrical connections 812, 814 to the circuit board 702.

The surface mount bars 722, 726 can be low-cost copper bars suitable for high current distribution around the power board 600. The bars 722, 726 can be surface-mounted and soldered onto by power board 500 using a surface mount reflow soldering process. The surface mount bars 722, 726 create an equal-resistance path for the multiple parallel circuits or phases 724A-D on the power board 500. Using the surface mount bars 722, 726 allows the power board 500 to not include separate input and output connectors for each individual power circuit or phase 724A-D.

In an example implementation, the power board 500 is a rack mountable module. The power input and output connectors 712 and 716 are on one side of the power board 500, so that the electric current flows down the length of the power board 500 and back to the same side of power board 500. As illustrated in FIG. 6, this distance can be different for the phases 724A-D when the multiple parallel phases 724A-D are stacked down the length of the PCB. It is desirable to achieve require symmetry in power distribution among the phases 724A-D, and the surface mount bars 722, 726 accordingly provide a low-resistance path to each of the phases 724A-D, eliminating the need to rely on separate inputs and on the wiring of the power board 500 that would provide higher resistance.

Referring again to FIG. 7-9, the contactor bus bars 712, 714, 716, 812 address the power distribution problem between two or more power converter PCBs such as power boards 500 and eliminate the need for a harness. The contactor bus bars 712, 714, 716, 812 can be heavy copper bus bars soldered to the contactor board 702 using a through hole reflow soldering process for example.

It is noted that the contactor bus bars 712, 714, 716, 812 provide both an electrical and mechanical connectivity between power boards 500 and the contactor board 702. In particular, the power board 500 can be rack mounted and in turn can mechanically support the contactor board 702. This approach provides high-density power distribution between the power converter boards 500 with components that are easy to fabricate and assemble.

### Thermally Enhanced Inductor

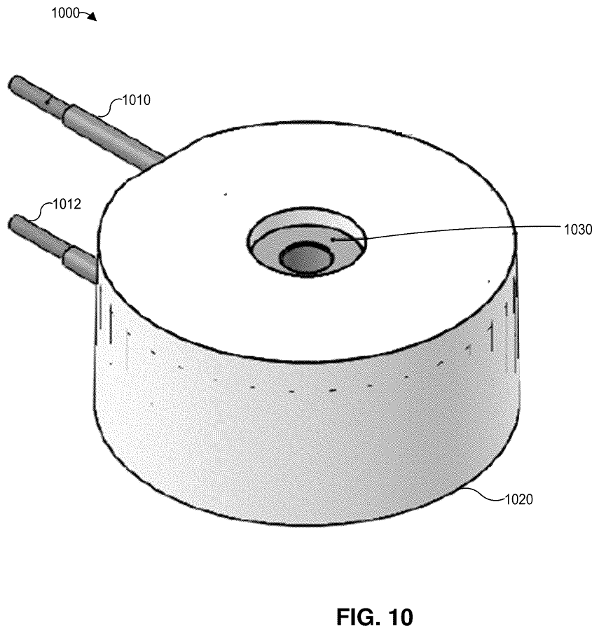

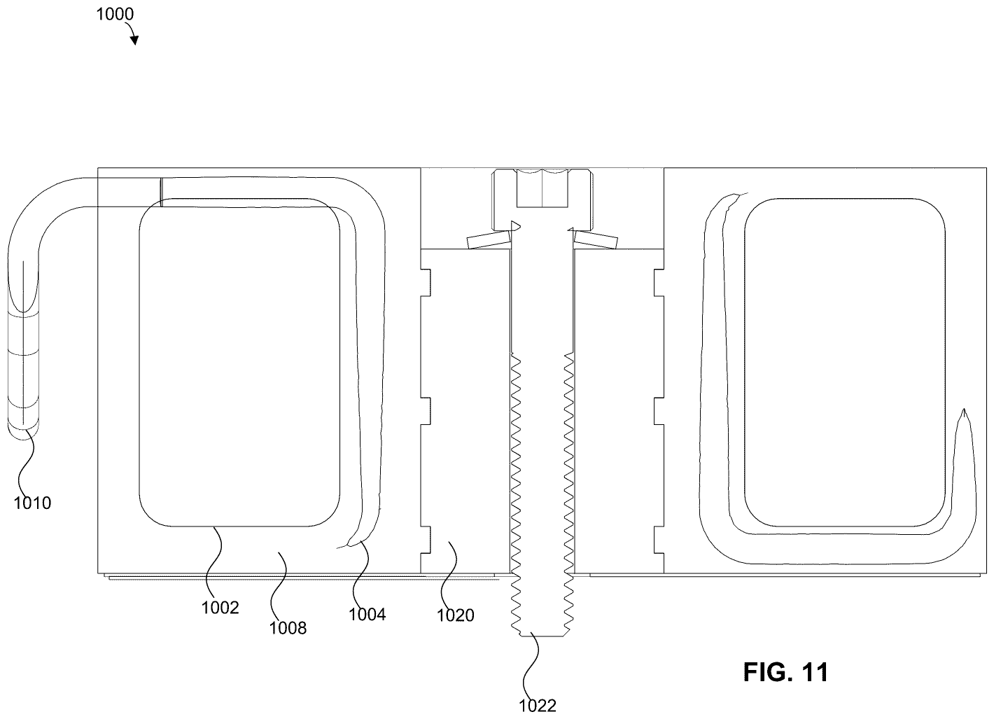

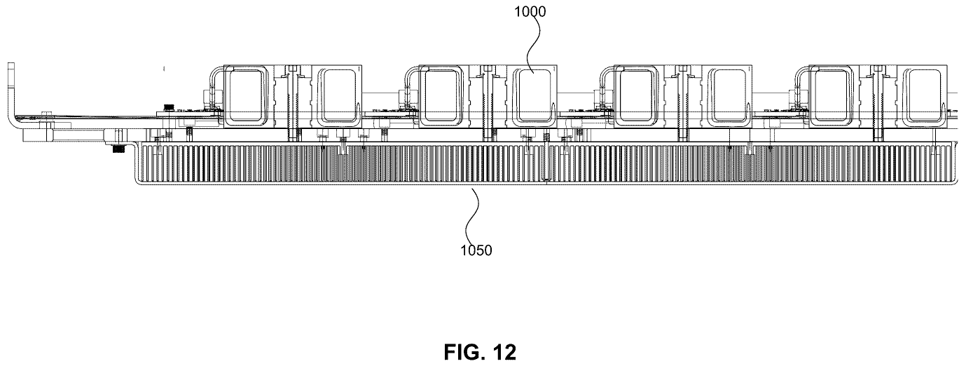

FIGS. 10-12 illustrate a thermally enhanced inductor 1000 that can operate in a charging station discussed above. As best seen in the cross-sectional view of FIG. 11, the thermally enhanced inductor 1000 includes a toroidal core 1002, a wire 1004 wound around the toroidal core 1002, and thermally conductive potting material or compound 1008 encapsulating the wire 1004. The potting compound 1008 encapsulates the wire-wound inductor for enhanced thermal cooling through the heatsink 1050 (as seen in FIG. 12).

Further, a spacer 1020 inside the hole defined by the toroidal core 1002 receives a rod 1022. The rod 1022 can be composed of aluminum, for example. The rod 1022 presses the potted body of the inductor 1000 against the heatsink 1050 so that there is pressure on the inductor 1000 toward the heatsink 1050 for better cooling. The rod 1022 also provides a higher conductivity thermal path for heat generated at the top of the inductor 1000, i.e., on the side opposite the one facing the heatsink 1050.

In some implementations, the wire at the top and bottom of the core 1002 is confined to an “ironed layer” to define a thin, dense copper area with a fill factor of approximately 80%. This allows the thermally enhanced inductor 1000 to reduce thermal conductivity from the core 1002 to the bottom surface of the inductor 1000, against the heatsink 1050.

It is noted that the potting compound 1008 also improves electric isolation of the wire 1004.

In some implementations, the potting compound 1008 is a thermally conductive epoxy (e.g., MG Chemicals 832TC). The spaces 1020 can be an aluminum unthreaded spacer (e.g., ¾″ OD, 1 1/18″ long, 5/16 screw size). The core 1002 can be an electromagnet from Magnetics Inc. Km High Frequency, for example. The wire 1004 can be Litz Wire, 14 AWG unreserved single build, 5-42-39 stranding 2×33 T. More specifically, five bundles of 52 strands of 0.008 mm 2×2 parallel 33 turns of Litz Wire can be used, so that the wire 1004 is flat on the top and bottom of the core 1002, resulting in a single layer at the top and at the bottom.

Finally, electrical high-temperature insulating tube sleeving 1010 such as 4 AWG Glass F Grade A suflex acryflex can be used to insulate the contacts of the thermally enhanced inductor 1000.

### Other Considerations

Although the preceding text sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. No claim element is to be construed as a means plus function unless the element is expressly recited using the phrase “means for.”

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Unless specifically stated otherwise, the term “some” refers to one or more. Likewise, use of the “a” or “an” are employed to describe elements and components of the embodiments herein. This is done merely for convenience and to give a general sense of the description. This description, and the claims that follow, should be read to include one or at least one and the singular also includes the plural unless the context clearly indicates otherwise.

Upon reading this disclosure, those of skill in the art will appreciate still additional alternative structural and functional designs for the systems and a methods disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A charger for an electric vehicle (EV), the charger comprising:
a printed circuit board (PCB) on which a plurality of power circuits defining respective phases of a multi-phase power conversion circuit are disposed along a first dimension;
a conductive input bus bar mounted on a surface of the PCB and extending along the first dimension;
a conductive output bus bar mounted on the surface of the PCB and extending along the first dimension parallel to the input bus bar;
an input connector disposed at an end of the input bus bar, configured to receive input power for the plurality of power circuits; and
an output connector disposed at an end of the output bus bar, configured to receive output power from the plurality of power circuits;
wherein the input bus bar and the output bus bar provide a substantially equal, low-resistance resistance path for current distribution to each of the plurality of power circuits.

2. The charger of claim 1, wherein the input conductive bus bar and the output conductive bus bar are shaped as rectangular cuboids.

3. The charger of claim 1, wherein the input conductive bus bar and the output conductive bus bar are composed of copper.

4. The charger of claim 1, wherein the input conductive bus bar and the output conductive bus bar are soldered onto the surface of the PCB.

5. The charger of claim 1, wherein:
the PCB is a rack-mountable module, and
the input connector and the output connector are disposed along a same side of the PCB to define a flow of current via the input connector, along the input bus bar, along the output bus bar in an opposite direction relative to the input bus bar, and out via the output connector.

6. The charger of claim 1, wherein the phases of the multi-phase power conversion circuit are connected in parallel.

7. The charger of claim 1, wherein each of phases of the multi-phase power conversion circuit includes an inductor.

8. The charger of claim 7, wherein the inductor includes:
a toroidal core with a central hole configured to receive a rod,
a wire wound around the toroidal core, and
a thermally conductive potting encapsulating the wire to define a cylindrical potted body of the inductor with a bottom surface and a top surface opposite the bottom surface.

9. The charger of claim 8, further comprising:
a heatsink adjacent to the bottom surface of the cylindrical potted body;
wherein the rod presses the potted body against the heatsink.

10. The charger of claim 8, wherein the wire near the bottom surface and the top surface is confined to a respective layer with an approximately 80% fill factor.

11. The charger of claim 1, wherein the PCB is free of separate inputs and outputs for the phases of the multi-phase power conversion circuit.

12. The charger of claim 1, wherein:
the PCB is a first PCB;
the charger further comprising:
a contactor board oriented perpendicular to the first PCB and a second PCB, the contactor board configured to electrically connect to the first PCB and the second PCB via contactor bus-bars soldered to the contactor board perpendicular to a surface of the contactor board.

13. The charger of claim 11, wherein the contactor bus-bars are soldered to the contactor board using a hole reflow soldering process.

14. The charger of claim 11, wherein contactor bus-bars mechanically engage the first PCB and the second PCB so that the first PCB and the second PCB structurally support the contactor board.

15. The charger of claim 11, wherein the contactor bus-bars are shaped as a pair of plates spaced apart to as to receive an edge of the first PCB or an edge or the second PCB between the plates.

16. The charger of claim 11, wherein the contactor bus-bars are composed of copper.

17. An assembly in a charger for an electric vehicle (EV), the assembly comprising:
a contactor board including first and second contactor bus-bars soldered to the contactor board perpendicular to a surface of the contactor board;
a first rack-mountable printed circuit board (PCB) in a perpendicular orientation relative to the contactor board, the first rack-mountable PCB mechanically supporting the contactor board via the first contactor bus-bars;
a second rack-mountable PCB in he perpendicular orientation relative to the contactor board and parallel to the first rack-mountable PCB, the second rack-mountable PCB mechanically supporting the contactor board via the second contactor bus-bars; wherein
the first PCB and the second PCB are electrically connected via the first contactor bus-bars and the second contactor bus-bars.

18. The assembly of claim 17, wherein the contactor bus-bars are soldered to the contactor board using a hole reflow soldering process.

19. The assembly of claim 17, wherein the first contactor bus-bars are shaped as a pair of plates spaced apart to as to receive an edge of the first PCB between the plates.

20. The assembly of claim 17, wherein the first and second contactor bus-bars are composed of copper.
